(19) United States
(12) Patent Application Publication
(10) Pub. No.: US 2011/0016069 A1
(43) Pub. Date: Jan. 20, 2011

(54) System and method for voice of the customer integration into insightful dimensional clustering

(76) Inventors: Eric A. Johnson, Longmont, CO (US); Don Kainer, Longmont, CO (US); Adrian Fan, Longmont, CO (US)

Correspondence Address: BROWNSTEIN HYATT FARBER SCHRECK, LLP, 410 SEVENTEENTH STREET, SUITE 2200, DENVER, CO, 80202, US

(21) Appl. No.: 12/799,216

(22) Filed: Apr. 19, 2010

Related U.S. Application Data
(60) Provisional application No. 61/170,232, filed on Apr. 17, 2009.

(51) Int. Cl. G06F 15/18

(52) U.S. Cl. 706/20

(57) ABSTRACT

A computer implemented method utilizing Insightful Dimensional Clustering (IDC) to extrapolate characteristics of subscribers that contact customer care to the entire subscriber base is disclosed. The combination of interaction content and IDC results in the spread of rich interaction characteristics to the entire subscriber base resulting in groupings of subscribers with similar characteristics including behavior, preferences, complaints, churn propensities, and pertinent retention offers.

### RELATED APPLICATIONS

This applications claims priority from U.S. Provisional Application No. 61/170,232, filed Apr. 17, 2009, which is hereby incorporated by reference.

### BACKGROUND

Customer interactions are a rich, yet commonly unused form of data which when married with transactional data, provide an enhanced view of a subscriber base. Not only is specific information known about why each subscriber is unhappy and likely to churn, these additional insights significantly increase targeted offer development to reestablish loyalty. While transactional data often exists for an entire subscriber base, interaction content is only available for subscribers that contact customer care. On average, 5% of a wireless company's subscriber base calls customer care each month.

### BRIEF SUMMARY

One aspect of the present invention provides a computer implemented method for identifying a segment of a population having a target behavior within a larger population within a data space using customer contact center analytics using a clustering algorithm. The computer implemented method includes identifying a plurality of dimensions to be used in the clustering algorithm and thereafter creating a plurality of category mentions for categorizing contact with a customer contact center and then recording interactions within a segment of population that contacts the customer contact center. The interactions are then categorized into the plurality of category mentions based upon predetermined words. The plurality of category mentions are sorted to identify one or more highly mentioned interaction categories. The number of dimensions to be used in the clustering algorithm is then narrowed from a plurality of dimensions to a set of initial dimensions based upon at least one of the plurality of category mentions. A tag is defined from exemplar data within the data space from the population having a known behavior and then refined based upon insights from at least one of the plurality of category mentions. The computer implemented method then segments the population within the data space into clusters using the clustering algorithm, analyzes the resulting clusters for a high tag concentration, and displays the resulting clusters.

### BRIEF DESCRIPTION OF THE DRAWINGS

FIG. 1 illustrates a block diagram of a computing system for identifying a segment of a population having a target behavior within a larger population within a data space using insights obtained from a population having known behavior;

FIG. 2 illustrates the insightful dimensional clustering process;

FIG. 3 shows an example of contact center analysis;

FIG. 4 shows an example of using the IDC process with speech analytics;

FIG. 5 illustrates another IDC example; and

FIG. 6 shows an example of a hot spot analysis.

### BRIEF DESCRIPTION

The scope of this invention comprises the integration of interactional information, such as contact center analytics, into Insightful Dimensional Clustering (IDC), which is the subject of a concurrently filed patent application, serial no. ______, titled “SYSTEM AND METHOD FOR INSIGHTFUL DIMENSIONAL CLUSTERING,” filed Apr. 17, 2010, the entirety of which is incorporated by reference for all purposes. IDC is a process of clustering, analysis, and refinement where the user has strong knowledge about the dimensions in the data and aims to focus in on target segments within the data space. The present invention utilizes IDC to extrapolate characteristics of subscribers that contact customer care to the entire subscriber base. The combination of interaction content and IDC results in the spread of rich interaction characteristics to the entire subscriber base resulting in groupings of subscribers with similar characteristics including behavior, preferences, complaints, churn propensities, and pertinent retention offers. A general overview of the general IDC process follows, including a description of IDC using insights from “voice of the customer” analytics in accordance with the present invention.

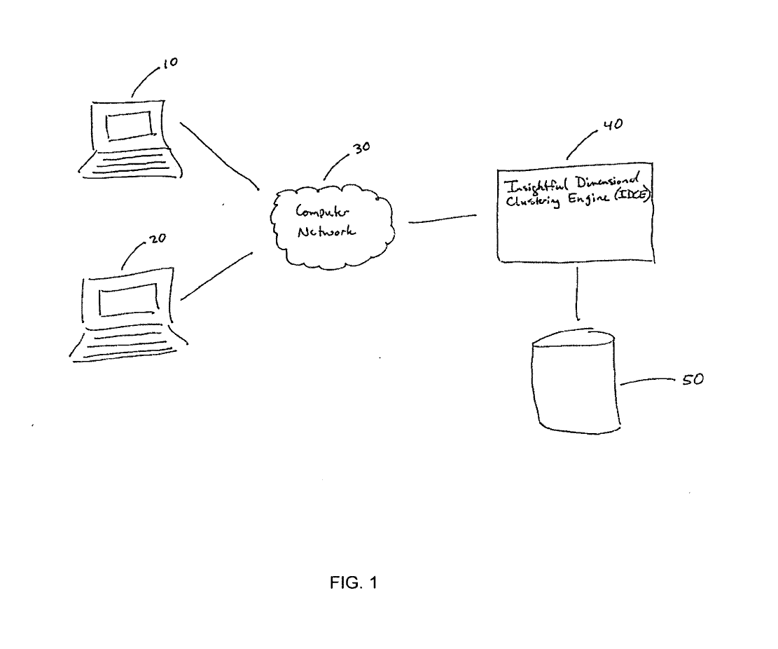

FIG. 1 illustrates an example block diagram of a computing system for providing a segmentation analysis based upon a clustering algorithm in accordance with the present invention. Various computer generated displays of high tag concentrations can be created and displayed to a user with respect to various issues relating to identifying a segment of a population having a target behavior within a larger population of a data space using insights obtained from a population having known behavior using a clustering algorithm—such as but not limited to, identifying a plurality of dimensions to be used in the clustering algorithm; narrowing the number of dimensions to be used in the clustering algorithm from a plurality of dimensions to a set of initial dimensions based upon analytics from various sources; defining the tag from target behavior data within the data space from the population having a known behavior; refining the tag based upon insights from the larger population within a data space; segmenting the population within the data space into clusters using the clustering algorithm; analyzing the resulting clusters for a high tag concentration; and displaying the resulting clusters.

As shown in FIG. 1, the system may include one or more terminals 10, 20 communicatively coupled over a network 30 to an insightful dimensional clustering engine 40. One or more databases 50 can be used to store and make available information such as flags, dimensions, analytics and transactional variables. The databases can be implemented using conventional database technology, including local databases, networked storage devices, or other conventional technologies.

The insightful dimensional clustering engine 40 may perform various functions described herein, including performing an iterative process to determine the identity of dimensions that are important to the tag and the identity of the segment of a population having a target behavior, segmenting the population within the data space into clusters, analyzing the resulting clusters for a high tag concentration, and displaying the resulting clusters to name a few. The insightful dimensional clustering engine 40 may be implemented as one or more processes operating on a computer or server, or may be a specially adapted computer or hardware device configured to perform the one or more operations described herein. The insightful dimensional clustering engine 40 can include a program, applet or graphical user interface to gather information from users, receive commands, and provide displays of results to users.

In accordance with one example of the present invention, using a clustering algorithm in conjunction with the insightful dimensional clustering engine 40, the computer implemented method of the present invention identifies one or more customers having a target behavior within a larger population of customers within a telecommunication carrier data space using insights obtained from customers having known behavior. One or more variables or corresponding data related to the insightful dimensional clustering engine 40 for identifying a plurality of dimensions to be used in the clustering algorithm, creating a plurality of category mentions for categorizing contact with a customer contact center, recording interactions within a segment of population that contacts the customer contact center, sorting the plurality of category mentions to identify one or more highly mentioned interaction categories, or defining a tag from exemplar data within the data space from the population having a known behavior may be stored, either temporarily or permanently, in a database accessible by (or data made available to) the insightful dimensional clustering engine 40. The insightful dimensional clustering engine 40 can then segment the population of customers within the data space into clusters using the clustering algorithm, analyze the resulting clusters for a high tag concentration so as to identify dimensions having a defined variance to the tag, and display the resulting clusters.

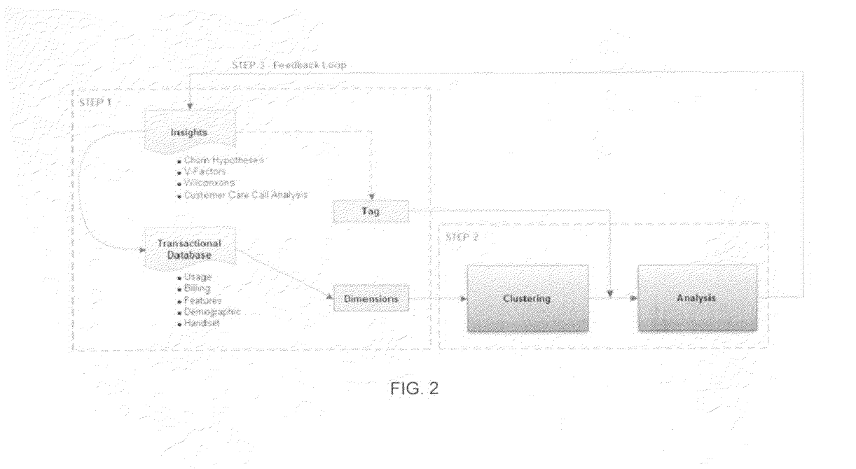

FIG. 2 depicts one embodiment of the IDC process in detail. As shown, in the first stage of IDC, a user contributes insightful narrowing of the dimensions which to cluster on based on analytics from various sources (e.g., V-factors, speech data, reports, or familiarity with the data). Thus, the vast space of dimensions to cluster on is narrowed to a few specific dimensions (in a transactional database for example). The tag is then defined by a target behavior within the data space from a population having a known behavior. In one example, the behavior may be the troublesome phenomenon in the subscriber base, such as a churn propensity flag.

In the illustrated example, the second stage of the process uses a clustering algorithm to segment the population. The subsequent divisions vary in the concentration of the defined tag. The IDC process uses a naive k-nearest neighbor algorithm, an extremely robust clustering algorithm that has been well documented throughout machine learning literature. The process uses random initial points and repetition to ensure robustness. The distance metric is either a weighted Euclidean distance or normalized dimensions to prevent skewing. Generally, very little is done to alter the distance metric to achieve proper clusters. Changes in the weights usually produce similar clusters. The dimensions that are clustered on use units of a similar order (monetary, time, etc.). If units must be crossed, there is usually an insight that aids in balancing these dimensions, which is considered in the first step of the process (for example: 500 minutes is approximately $5 on a rate plan).

As stated previously, the insightful dimensional clustering engine 40 runs the clustering algorithm. During clustering (i.e., the second stage of the process), the present invention optimizes the following equation and minimizes the distance from all points to each cluster's center:

$${{arg min}_{S} {\sum }_{i = 1}^{k} {\sum }_{{x}_{j} ε {S}_{i}}}_{where {μ}_{i} is the mean of {S}_{ρ}} {\vert {x}_{j} - {μ}_{i} \vert}^{2}$$

arg min=find the minimum argument which satisfies . . . (basically, find the best fit)

S=The set of points which create 1 Cluster; is composed of many x

u=the mean of the cluster (i.e., its center)

x=one of our data points

k=the number of total clusters allowed (chosen at beginning)

There are ‘k’ cluster points. What this equation demonstrates is that by minimizing and resorting to cluster centers, the invention will find centers with the smallest Euclidean distance to the most amount of points.

During the third stage of the process shown in FIG. 2, the user analyzes the clusters for high tag concentration, referred to as hot spot analysis. Upon analysis, the process is repeated by either eliminating dimensions which were not significant in the hot spot analysis, refining the tag to be more specific, or refining the tag to be more general. The iterative process provides information on which dimensions are important to a chosen tag and which segments of the population contain these abnormal tag concentrations.

The following equation is a standard variance measure that the present invention uses during hot spot analysis (third stage of the process):

$${s}_{N} = \sqrt{\frac{1}{N} {\sum }_{i = 1}^{N} {( {x}_{i} - \overline{x} )}^{2}}$$

N=the top few entries, after sorting by tag concentration that have meaning

X with bar=The mean of that dimension

Xᵢ=a given point in our data set

There is the assumption that this measure is only looking at one dimension of data. In this case, the present invention is calculating S_{N} which is the variance of the final cluster centers. X with a bar over it represents the mean of the cluster centers, with Xᵢ representing each cluster center. The present invention searches through the first N relevant clusters (e.g., sort by highest tag concentration and march down the first 10-20 or so) and calculate S_{N}. After calculation, the ratio of S_{N} versus X with a bar is our final measure to determine whether a dimension was relevant or not.

Since the tag is representative of a target behavior in the customer population, IDC identifies specific segments of the population with abnormally high target behavior. Customers within defined clusters that have not yet displayed tag behavior are then acted on, as they are more likely to display the tag behavior in the future. Thus, insights from customers with known behaviors and propensities are extended to customers that have not yet displayed these behaviors.

Convergence is achieved when clusters change very little from iteration to iteration. Clusters with abnormally high targeted behavior (i.e., tag concentration) are comprised of subscribers that have not yet displayed tag behavior. These subscribers are then prioritized for intervention, as they are more likely to display the tag behavior in the future. Thus, insights from subscribers with known behaviors and propensities are extended to subscribers that will potentially display these behaviors.

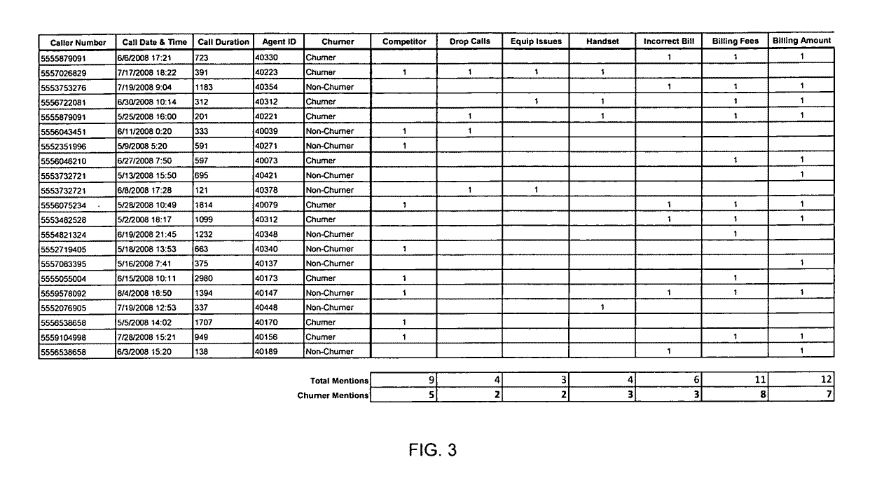

Whether for quality assurance, training, or compliance reasons, most customer contact centers record between 5-100% of customer interactions. Advanced interaction analytic engines have the ability to automatically transcribe customer interactions and categorize them based on mentioned words and phrases. Within the scope of the present invention, categories are customized to provide specificity and detail concerning the reason(s) for each interaction. A few representative examples of categories within the telecommunications industry are billing, service, equipment, competitive mention, and dissatisfaction. Single words and phrases may also belong to more than one category. For example, the phrase “charged extra” could be associated to the categories “Billing Fees” and “Incorrect Bill”. FIG. 3 illustrates an example of contact center analysis, including the categories mentioned during the interaction, the subscriber's phone number, and if the subscriber has churned.

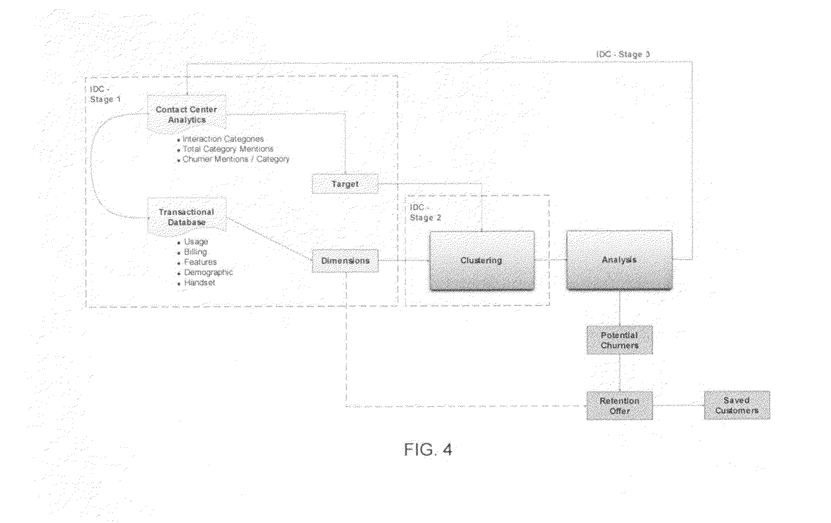

Although a small percentage of the subscriber base provides interaction data each month, interaction data is richer and more specific than transactional data. In accordance with one aspect of the present invention, the IDC process is used to identify which subscribers behave similarly to those that have contacted customer care. FIG. 4 depicts the IDC process utilizing contact center analytics.

As shown in the illustrated example, the first step of extrapolating customer care analytics to the subscriber population is evaluating the category mentions from a sampling of interactions. Categories mentioned frequently by subscribers that churn are key insights into subscriber dissatisfaction and attrition. The IDC process then utilizes highly mentioned interaction categories to reduce the dimensions for the clustering algorithm in insightful dimensional clustering engine (“IDCE”) 40. As interaction categories relate to dimensions within the transactional data space, the initial dimension selection aspect of IDC is simplified. A tag is also specified to mark targeted interactional phenomena in the resulting clusters.

Continuing with the illustrated example of FIG. 4, the IDC process algorithmically clusters the population into segments where the subsequent divisions vary in the concentration of the given tag. Segments with abnormally high representation of tag behavior are based on a specific interaction category. Since the tag is defined by an aspect of contact center analysis, targeted segments of the population reference a specific issue providing greater insight than transactional data alone.

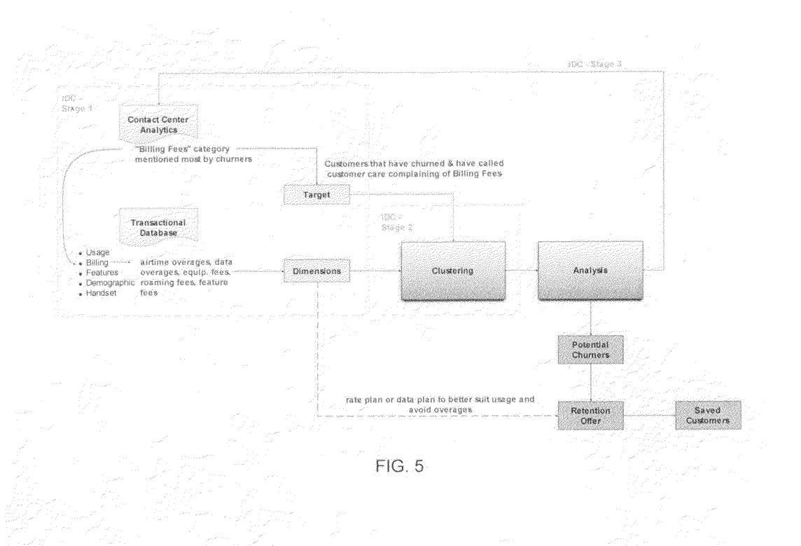

The following is an example describing the process of integrating contact center analytics into a transactional database in the telecommunications industry, as shown in FIG. 5. For the illustrated example, assume that Telecommunications Provider XYZ records 50% of its call center interactions. Through advanced voice analytics, subscriber calls are automatically categorized based on mentioned words and phrases. For example, if a subscriber calls and says “switch carriers” and “charged me extra”, the call is categorized under both “Competitive Mention” and “Billing Fees”. Once the calls have been transcribed and categorized, the subsequent categories are sorted by highest mention. This analysis provides insight into the root causes of subscriber attrition, as a subscriber specifically states why they are unhappy. For example, if the category “Billing Fees” was mentioned most by subscribers that churned, there may be an issue with billing fees leading to subscriber attrition.

Continuing with the illustrated example, once insights of subscriber attrition are identified from contact center analysis, these high churner categories are used to determine the initial dimensions for clustering in IDC. The interaction category “Billing Fees” is related to transactional variables such as ‘airtime overages’, ‘data overages’, ‘equipment fees’, ‘roaming fees’, and ‘feature fees’. These dimensions become the space in which the algorithm clusters. Subscribers that churned and mentioned “Billing Fees” are tagged as the targeted behavior.

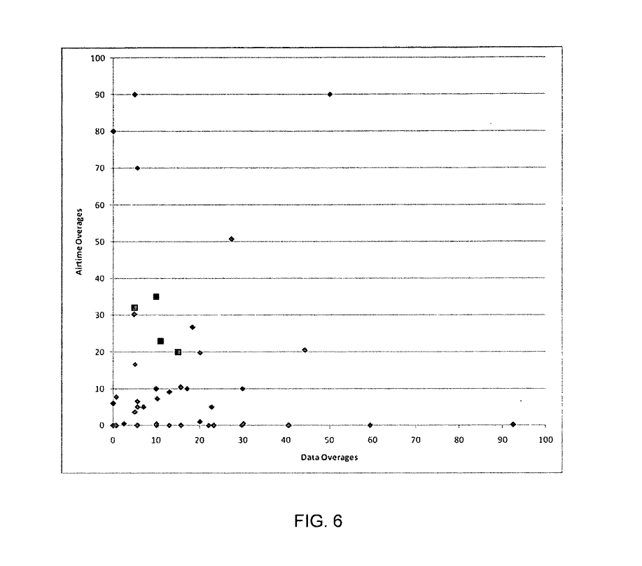

During an iteration of IDC, a clustering algorithm segments the population. At the completion of each iteration, hot spot analysis examines the clusters with high tag concentration. In this example, after several iterations a consistent pattern evolves where clusters with data overages of $5-15 and airtime overages of $20-35 have abnormally high tag concentration. FIG. 6 illustrates the results of the hot spot analysis, where the red clusters have high concentration of subscribers that churned mentioning “Billing Fees”.

Within these targeted clusters, insights from the tag (churn reasons and propensities) have been extrapolated to subscribers in the cluster not yet exhibiting these behaviors. Subscribers within these clusters that have not churned yet are contacted and extended an appropriate retention offer, such as a rate plan or data plan to better suit usage needs and avoid overage charges. Thus, utilizing interaction data allows IDC to focus in on problem clusters based on specific subscriber issues providing stronger actionable analytics.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

While the invention has been particularly shown and described with reference to various embodiments thereof, it will be understood by those skilled in the art that various other changes in the form and details may be made without departing from the spirit and scope of the invention.

We claim:

1. A computer implemented method for identifying a segment of a population having a target behavior within a larger population within a data space using customer contact center analytics, the method using a clustering algorithm, said method comprising:
identifying a plurality of dimensions to be used in the clustering algorithm;
creating a plurality of category mentions for categorizing contact with a customer contact center;
recording interactions within a segment of population that contacts the customer contact center;
categorizing the interactions into the plurality of category mentions based upon predetermined words;
sorting the plurality of category mentions to identify one or more highly mentioned interaction categories;
narrowing the number of dimensions to be used in the clustering algorithm from a plurality of dimensions to a set of initial dimensions based upon at least one of the plurality of category mentions;
defining a tag from exemplar data within the data space from the population having a known behavior;
refining the tag based upon insights from at least one of the plurality of category mentions;
segmenting the population within the data space into clusters using the clustering algorithm;
analyzing the resulting clusters for a high tag concentration; and
displaying the resulting clusters.

2. The computer implemented method of claim 1, wherein the predetermined words are grouped into one or more predetermined phrases.

3. The computer implemented method of claim 1, wherein an interaction analytic engine performs the step of categorizing the interactions by first transcribing the contact with the customer contact center.

4. The computer implemented method of claim 1, further comprising the step of customizing categories to provide specificity and detail concerning the reason for a contact with the customer contact center.

5. The computer implemented method of claim 1, wherein the plurality of category mentions are chosen from a group inclusive of billing, services, equipment, usage, competitive mention and dissatisfaction.

6. A computer implemented method for identifying one or more customers having a target behavior within a larger population of customers within a telecommunication carrier data space using customer contact center analytics, the method using a clustering algorithm, said method comprising:
identifying a plurality of dimensions to be used in the clustering algorithm from a plurality of transactional variables within a transactional database;
creating a plurality of category mentions for categorizing contact with a customer contact center;
recording interactions with a plurality of customers that contact the customer contact center;
categorizing the interactions with the plurality of customers that contact the customer contact center into the plurality of category mentions based upon predetermined words;
sorting the plurality of category mentions to identify one or more highly mentioned interaction categories;
narrowing the number of dimensions to be used in the clustering algorithm from the plurality of dimensions to a set of initial dimensions using the transactional variables related to the highly mentioned interaction categories;
defining the tag from the highly mentioned interaction categories;
segmenting the population of customers within the data space into clusters using the clustering algorithm;
analyzing the resulting clusters for a high tag concentration so as to identify dimensions having a defined variance to the tag; and
displaying the resulting clusters.

7. The computer implemented method of claim 6, further comprising the step of performing an iterative process to determine the identity of dimensions that are important to the tag from the initial dimensions and the identity of the customers having a target behavior.

8. The computer implemented method of claim 6, further comprising:
identifying the one or more customers having a target behavior from the relationship between the tag and the initial dimensions; and
offering an action from the telecommunications carrier that addresses the target behavior.
